(19) United States
(12) Patent Application Publication
(10) Pub. No.: US 2015/0055184 A1
(43) Pub. Date: Feb. 26, 2015

(54) System And Method For Print Density Adjustment To Reduce Banding

(71) Applicant: Xerox Corporation, Norwalk, CT (US)

(72) Inventor: Guo-Yau Lin, The Woodlands, TX (US)

(73) Assignee: Xerox Corporation, Norwalk, CT (US)

(21) Appl. No.: 13/974,617

(22) Filed: Aug. 23, 2013

(51) Int. Cl. H04N 1/405

(52) U.S. Cl. CPC H04N 1/405
USPC 358/3.06

(57) ABSTRACT

A method of operating an inkjet printer modifies image data for an image to be printed to reduce or eliminate variations in color intensity within the printed ink image. Intensity adjustment parameters are identified with reference to variations in a frequency of a signal generated by a sensor that corresponds to movement of a media web through a print zone in the inkjet printer. The image data is modified with the intensity adjustment parameters, and the image is printed with reference to the modified image data.

### TECHNICAL FIELD

This disclosure relates generally to printers that form color printed images on an image receiving surface and, more particularly, to printers that generate printed patterns on a moving image receiving surface.

### BACKGROUND

Color half-tone printing devices deposit marking agents, such as ink or toner, having a small number of colors onto an image receiving surface to form a printed image. The marking agent is deposited in sufficiently small quantities to enable the human eye to perceive a large number of potential colors from different combinations of the marking agents. For example, many printers use cyan, magenta, yellow, and black (CMYK) marking agents to form multi-color printed images. For example, in an inkjet printer, different groups of inkjets eject CMYK inks in predetermined half-tone drop patterns to form the color images on an image receiving surface, such as a paper print medium or an indirect imaging drum or belt, which receives ink prior to transferring the ink to a print medium.

One type of half-tone color printer is a direct to media drop on demand inkjet printer. Drop on demand inkjet technology is employed in commercial products such as printers, plotters, and facsimile machines. Generally, an inkjet image is formed by selectively ejecting ink drops from a plurality of inkjets, which are arranged in one or more printheads, onto an image receiving surface. In the inkjet printer, a print medium, such as paper, moves past an array of printheads that ejects ink drops of one or more colors of ink onto the paper to form a printed image. In a continuous web printer, an elongated roll of paper unwinds and moves through a media transport path in the printer in a “media web” configuration. The printer forms separate ink images for a large number of printed pages on the media web, and the printed web is cut into individual printed sheets after completion of the printing process.

During the printing process, the media transport uses one or more actuators and rollers to move the media web past the printheads for printing at a predetermined velocity. In some instances, the velocity of the media web varies as the media web passes the printheads. If the media web moves past the printheads at a higher or lower than expected velocity, then the ink drops from the printheads are formed over a larger or smaller than expected portion of the media web, respectively, which reduces or increases the perceived intensity of the printed ink, respectively. In some configurations, the velocity of the media web oscillates above and below the predetermined velocity, which results in a banding effect of alternating increased and reduced intensity bands of ink in the printed image. The banding effect reduces the perceived quality of printed images. While the media transport path includes various mechanical and electromechanical controls to reduce the variation in the velocity of the media web, some velocity variation in the media web may result in banding during the printing process. Consequently, improvements to inkjet printers that reduce or eliminate the effects of banding in printed images would be beneficial.

### SUMMARY

In one embodiment, a method of operating a printer has been developed. The method includes moving a media web in a process direction past a plurality of inkjets in a print zone, generating a signal corresponding to process direction movement of the media web with a sensor, identifying variations in a frequency of the signal from the sensor, identifying a plurality of intensity adjustment parameters for a printed image with reference to the identified variations in the frequency of the signal from the sensor, modifying image data for the printed image with reference to the plurality of identified intensity adjustment parameters, and ejecting ink drops to form the printed ink image on the media web with reference to the modified image data to reduce or eliminate variations in an intensity of the printed ink image.

In another embodiment, a printer that forms printed images has been developed. The printer includes a media transport configured to move a media web in a process direction past a plurality of inkjets in a print zone, a sensor operatively connected to a member in the media transport and configured to generate a signal in response to movement of the media web, a memory configured to store a plurality of predetermined intensity adjustment parameters for a printed image with reference to a plurality of frequencies of the signal from the sensor, and a controller operatively connected to the inkjets, the sensor, and the memory. The controller is further configured to identify variations in the frequency of the signal from the sensor, identify a plurality of intensity adjustment parameters for a printed image with reference to the identified variations in the frequency of the signal from the sensor and the predetermined intensity adjustment parameters stored in the memory, modify image data for the printed image with reference to the plurality of identified intensity adjustment parameters, and generate firing signals to eject ink drops from the plurality of inkjets onto the media web to form the printed image with reference to the modified image data to reduce or eliminate variations in an intensity of the printed ink image.

### BRIEF DESCRIPTION OF THE DRAWINGS

The foregoing aspects and other features of a printer that modifies a printing process to reduce or eliminate banding in printed images are explained in the following description, taken in connection with the accompanying drawings.

FIG. 1 is a block diagram of a process for modifying image data and printing an image with the modified image data in an inkjet printer to reduce or eliminate banding in the printed image.

FIG. 2 is a diagram depicting variations in the velocity of the media web, changes in the frequency of signals that are received from a rotation sensor that monitors the movement of the media web, and corresponding variations in the separation between printed rows of ink drops that are printed on the media web.

FIG. 3 is a schematic diagram depicting lookup tables in a printer memory for adjustment of the intensity of image data in a printed image with reference to an identified rotational frequency and corresponding velocity of a media web in the printer.

FIG. 4 is a diagram of image data with default intensity values and adjustments to the intensity values of the image data to reduce the effects of banding in a printed image that is formed with reference the image data.

FIG. 5 is a depiction of a first image that includes banding and a second image with adjusted image data that produces another banding pattern to cancel the banding of the first image.

FIG. 6 is a block diagram of a process for identifying and correcting for banding due to variations in the density of printed ink drops for at different media web velocities.

FIG. 7A is a depiction of a printed test pattern that is formed on a media web without banding.

FIG. 7B is a depiction of the printed test pattern of FIG. 7A that is formed on the media web including banding due to variations in the velocity of the media web.

FIG. 8 is a schematic diagram of an inkjet printer that is configured to monitor variations in the velocity of a media web and to adjust image data to print images with reduced banding on the media web.

### DETAILED DESCRIPTION

For a general understanding of the environment for the system and method disclosed herein as well as the details for the system and method, reference is made to the drawings. In the drawings, like reference numerals have been used throughout to designate like elements. As used herein, the word “printer” encompasses any apparatus that produces images with colorants on media, such as digital copiers, bookmaking machines, facsimile machines, multi-function machines, etc.

As used herein, the term “pixel” refers to data that corresponds to an amount of colored ink at a location in a two-dimensional grid for an ink image to be produced in a print job. An image is represented by an arrangement of pixels with different colors at different locations in the image. As used herein, the term “intensity parameter” refers to a numeric value for the pixel corresponding to an intensity of a color for a pixel. For example, in an embodiment using 8-bit per color intensity parameters, the intensity parameter for each color separation in a pixel is assigned a value of between 0 and 255. An intensity parameter value of zero indicates that the color is not used in the pixel, while a parameter of 255 indicates a maximum intensity for the color, and intermediate values correspond to intermediate intensities. Perceptually, ink printed with low image intensity appears as a fainter and lighter printed color tone, while a higher intensity appears as a bolder and darker printed color tone. The term “contone pixel” refers to a pixel of image data that includes one or more intensity parameter values that correspond to an intensity of a pixel in a color separation for an image. In one embodiment, a pixel includes cyan, magenta, yellow, and black color (CMYK) separations and each of the contone pixels includes numeric four intensity parameters for the four CMYK separations.

As used herein, the term “continuous tone” or “contone” refers to a range of colors that can be represented by a single contone pixel in the image data. The overall color of a contone pixel is formed from the colors of the pixels in each color separation at the same position that form the contone pixel. In a theoretical contone plane, the colors in the plane change continuously over an infinite number of intermediate color levels between different colors. In a digital representation of image data for a contone pixel, the different colors in the plane are represented by discrete digital values, and the number of discrete digital values is large enough to produce a range of color levels that appear to be continuous to the human eye.

The overall color of the contone pixel is typically defined in a three or four dimensional color-space. Each color separation includes a contone parameter that represents different intensities of the individual color separation, such as the CMYK separations. A combination of intensity values for each of the color separations produces the visible color of the contone pixel.

As used herein, the terms “half-tone pixel” and “binary pixel” refer to a pixel in a single color separation, such as one of the CMYK separations, which is either activated or deactivated. An activated half-tone pixel corresponds to a location where the printer deposits marking agent, such as ink or toner, onto an image receiving surface, while a deactivated half-tone pixel corresponds to a location where the printer does not deposit the marking agent. In a CMYK printer, four sets of half-tone binary image data for each of the CMYK color separations are used to control the operation of a marking unit to form printed images. As described below, the printer generates half-tone pixels using threshold matrices to map contone intensity parameters into half-tone pixels. Half-toning processes including various forms of dithering and thresholding, which are used to convert contone pixels into binary image data that control the operation of a marking unit to form the printed image. As used in this document, a “marking unit” refers to a device that is operated with reference to half-tone data to apply colorant to a surface to form an image.

In a CMYK printer, colors in images are formed using combinations of one or more of the cyan, magenta, yellow, and black inks in a half-tone image pattern. In the digital image data, each contone pixel includes a set of values corresponding to locations in the contone planes for each of the CMYK color separations. A digital controller in the printer or associated with the printer converts the contone image data for each pixel into two-dimensional arrangements of half-tone binary pixels that each correspond to a single color separation in a printed page. Each of the half-tone binary image is a two-dimensional array of half-tone pixels that correspond to locations on the printed page where the printer either ejects an ink drop or does not eject an ink drop to form the printed image. In a CMYK color printer, the half-tone pixels for each of the CMYK color separations control the operation of inkjets for each of the CMYK ink colors to form color images. The printer superimposes the half-tone image pixels for each of the CMYK color separations on a single printed page where the ink drops for the different colors are positioned close to one another on the printed page. To the human eye, the different combinations of the CMYK inks form a large range of perceptible colors on the printed page.

As described above, digital contone image data include parameters that describe a wide range of colors for an individual contone pixel in digital image data. In a half-tone printed image, however, the combinations of CMYK ink drops in a small region that correspond to the size of the contone pixel are incapable of producing many of the colors that can be represented in each contone pixel. For example, many printer embodiments are configured to either print or not print a single ink drop of the CMYK colors onto a region of the image receiving surface that corresponds to the pixel. In a printer embodiment with four ink colors, and a white image receiving surface, such as paper, there are 2⁴ (16) potential combinations of ink drops on the paper and the option to refrain from printing any ink drops to leave the paper blank. The half-toning process converts a single contone pixel into larger arrays of binary image data corresponding to each of the color separations in the contone pixel, such as the CMYK separations. The half-tone process activates some or all of the binary pixels in the arrays based on the intensity parameter value of the color separation to form the printed color with a varying level of perceived intensity even though each pixel of half-tone image data only represents a binary on/off value. As described below, the printer is configured to adjust the intensity of contone intensity parameters for selected colors to enable accurate reproduction of the selected colors when the half-tone image is printed.

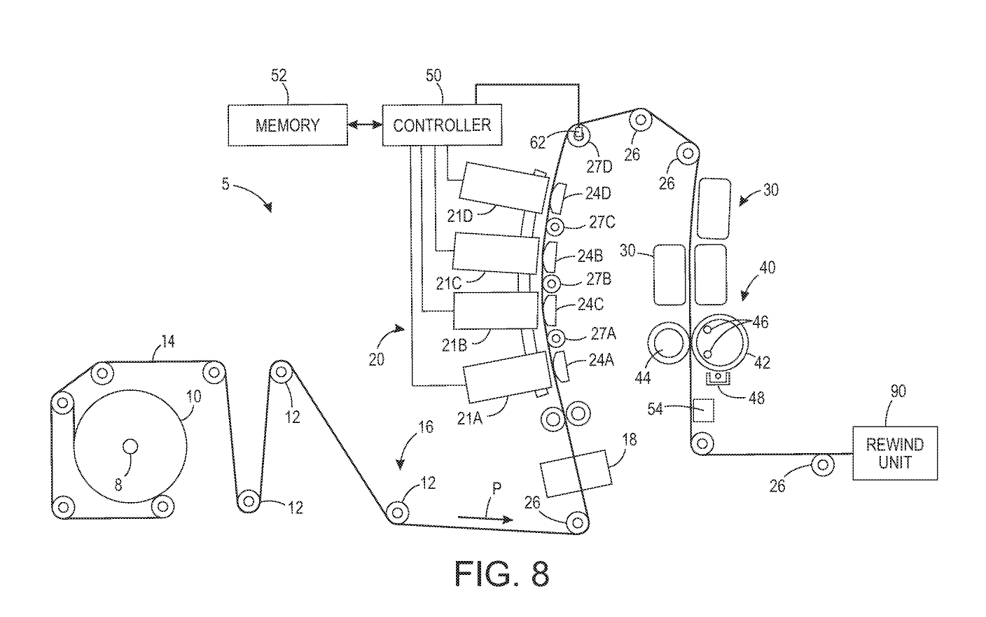

FIG. 8 depicts an inkjet printer 5. For the purposes of this document, an inkjet printer employs one or more inkjet printheads to eject drops of ink into an image receiving member, such as paper, another print medium, or an indirect member such as a rotating image drum or belt. The printer 5 is configured to print ink images with a “phase-change ink,” by which is meant an ink that is substantially solid at room temperature and that transitions to a liquid state when heated to a phase change ink melting temperature for jetting onto the imaging receiving member surface. The phase change ink melting temperature is any temperature that is capable of melting solid phase change ink into liquid or molten form. In one embodiment, the phase change ink melting temperature is approximately 70° C. to 140° C. As used herein, ink refers to melted solid ink, heated gel ink, or other known forms of ink, such as aqueous inks, ink emulsions, ink suspensions, ink solutions, or the like.

The printer 5 includes a controller 50 to process the image data before generating and delivering the firing signals to the inkjet ejectors to eject colorants and form an image. Colorants can be ink, or any suitable substance that includes one or more dyes or pigments, which is applied to the selected media. The colorant can be black, or any other desired color, and some printer configurations apply a plurality of distinct colorants to the media. The media includes any of a variety of substrates, including plain paper, coated paper, glossy paper, or transparencies, among others, and the media can be available in sheets, rolls, or other physical formats.

The printer 5 is an example of a direct-to-web, continuous-media, inkjet printer that includes a media supply and handling system configured to supply a long (i.e., substantially continuous) web of media W of “substrate” (paper, plastic, or other printable material) from a media source, such as spool of media 10 mounted on a web roller 8. The media web W includes a large number (e.g. thousands or tens of thousands) of individual pages that are separated into individual sheets with commercially available finishing devices after completion of the printing process. Some webs include perforations that are formed between pages in the web to promote efficient separation of the printed pages. For simplex printing, the printer 5 passes the media web W through a media conditioner 16, print zone 20, and rewind unit 90 once.

The media web W is unwound from the source 10 as needed and a variety of motors, not shown, rotate one or more rollers 12 and 26 to propel the media web W. The media conditioner includes rollers 12 and a pre-heater 18. The rollers 12 and 26 control the tension of the unwinding media as the media moves along a path through the printer. In alternative embodiments, the printer transports a cut sheet media through the print zone in which case the media supply and handling system includes any suitable device or structure to enable the transport of cut media sheets along a desired path through the printer. The pre-heater 18 brings the web to an initial predetermined temperature that is selected for desired image characteristics corresponding to the type of media being printed as well as the type, colors, and number of inks being used. The pre-heater 18 can use contact, radiant, conductive, or convective heat to bring the media to a target preheat temperature, which in one practical embodiment, is in a range of about 30° C. to about 70° C.

The media is transported through a print zone 20 that includes a series of printhead units 21A, 21B, 21C, and 21D, each printhead unit effectively extends across the width of the media and is able to eject ink directly (i.e., without use of an intermediate or offset member) onto the moving media. In printer 5, each of the printheads ejects a single color of ink, one for each of the colors typically used in color printing, namely the CMYK colors. The printhead units 21A-21D form a marking unit in the print zone of the printer 5 that deposits the CMYK ink drops onto the media web W to form half-tone color printed images. The controller 50 receives velocity data from encoders mounted proximately to rollers positioned on either side of the portion of the path opposite the four printheads to calculate the linear velocity and position of the web as the web moves past the printheads. The controller 50 uses these data to generate firing signals for actuating the inkjet ejectors in the printheads to enable the printheads to eject four colors of ink with appropriate timing and accuracy for registration of the differently colored patterns to form color images on the media. The inkjet ejectors actuated by the firing signals correspond to digital data processed by the controller 50. The digital data for the images to be printed can be transmitted to the printer, generated by a scanner (not shown) that is a component of the printer, or otherwise generated and delivered to the printer. In various configurations, a printhead unit for each primary color includes one or more printheads; multiple printheads in a single printhead unit are formed into a single row or multiple row array; printheads of a multiple row array are staggered; a printhead prints more than one color; or the printheads or portions thereof are mounted movably in a direction transverse to the process direction P for printing operations, such as for spot-color applications and the like.

Associated with each printhead unit is a backing member 24A-24D, typically in the form of a bar or roller, which is arranged substantially opposite the printhead on the reverse side of the media web W. Each backing member positions the media at a predetermined distance from the printhead opposite the backing member. The backing members 24A-24D are optionally configured to emit thermal energy to heat the media to a predetermined temperature, which is in a range of about 40° C. to about 60° C. in printer 5. The various backer members can be controlled individually or collectively. The pre-heater 18, the printheads, backing members 24A-24D (if heated), as well as the surrounding air combine to maintain the media along the portion of the path opposite the print zone 20 in a predetermined temperature range of about 40° C. to 70° C.

As the partially-imaged media web W moves to receive inks of various colors from the printheads of the print zone 20, the printer 5 maintains the temperature of the media web within a given range. The printheads in the printhead units 21A-21D eject ink at a temperature typically significantly higher than the temperature of the media web W. Consequently, the ink heats the media, and temperature control devices can maintain the media web temperature within a predetermined range. For example, the air temperature and air flow rate behind and in front of the media web W impacts the media temperature. Accordingly, air blowers or fans can be utilized to facilitate control of the media temperature. Thus, the printer 5 maintains the temperature of the media web W within an appropriate range for the jetting of all inks from the printheads of the print zone 20. Temperature sensors (not shown) can be positioned along this portion of the media path to enable regulation of the media temperature.

In the printer 5, a rotational sensor 62 is operatively connected to one of the rollers 27D that is located in the process direction P from the print zone 20. In the embodiment of the printer 5, the rotational sensor 62 is a Hall Effect sensor or an optical sensor with an encoder disk that generates electrical pulses in response to rotation of the roller 27D by a predetermined angle. The controller 50 receives the signal from the rotational sensor 62. The roller 27D rotates in response to the linear movement of the media web W, and the predetermined diameter and corresponding circumference of the roller 27A enables the controller 50 to identify movement and a linear velocity of the media web W. For example, in an embodiment where the sensor 62 generates a single pulse for a full rotation of the roller 27D, the media web W moves by a distance of πd millimeters for each pulse where d is the diameter of the roller 27D. The controller 50 monitors the frequency of the pulses in the signal from the sensor 62 to identify the velocity of the media web W and to identify variations in the velocity of the media web W. While FIG. 8 depicts a single sensor 62, in alternative embodiments multiple sensors monitor the rotation of different rollers that engage the media web W to identify variations in the velocity of the media web W at different locations along the media path. For example, in an alternative embodiment additional sensors monitor the rotation of some or all of the rollers 27A-27D to provide additional media web velocity data at different locations in the print zone that correspond to the printhead units 21A-21D, respectively.

Following the print zone 20 along the media path are one or more “mid-heaters” 30. A mid-heater 30 can use contact, radiant, conductive, and/or convective heat to control a temperature of the media. The mid-heater 30 brings the ink placed on the media to a temperature suitable for desired properties when the ink on the media is sent through the spreader 40. In one embodiment, a useful range for a target temperature for the mid-heater is about 35° C. to about 80° C. The mid-heater 30 has the effect of equalizing the ink and substrate temperatures to within about 15° C. of each other. Lower ink temperature gives less line spread while higher ink temperature causes show-through (visibility of the image from the other side of the print). The mid-heater 30 adjusts substrate and ink temperatures to 0° C. to 20° C. above the temperature of the spreader.

Following the mid-heaters 30, a fixing assembly 40 applies heat and/or pressure to the media to fix the images to the media. The fixing assembly includes any suitable device or apparatus for fixing images to the media including heated or unheated pressure rollers, radiant heaters, heat lamps, and the like. In the embodiment of the FIG. 8, the fixing assembly includes a “spreader” 40, which applies a predetermined pressure, and in some implementations, heat, to the media. The function of the spreader 40 is to flatten the individual ink droplets, strings of ink droplets, or lines of ink on web W and to flatten the ink with pressure and, in some systems, heat. The spreader flattens the ink drops to fill spaces between adjacent drops and form uniform images on the media web W. In addition to spreading the ink, the spreader 40 improves fixation of the ink image to the media web W by increasing ink layer cohesion and/or increasing the ink-web adhesion. The spreader 40 includes rollers, such as image-side roller 42 and pressure roller 44, to apply heat and pressure to the media. Either roller can include heat elements, such as heating elements 46, to bring the web W to a temperature in a range from about 35° C. to about 80° C. In alternative embodiments, the fixing assembly spreads the ink using non-contact heating (without pressure) of the media after the print zone 20. Such a non-contact fixing assembly can use any suitable type of heater to heat the media to a desired temperature, such as a radiant heater, UV heating lamps, and the like.

In one practical embodiment, the roller temperature in spreader 40 is maintained at an optimum temperature that depends on the properties of the ink, such as 55° C. Generally, a lower roller temperature gives less line spread while a higher temperature produces imperfections in the gloss of the ink image. Roller temperatures that are too high may cause ink to offset to the roller. In one practical embodiment, the nip pressure is set in a range of about 500 to about 2000 psi/side. Lower nip pressure produces less line spread while higher pressure may reduce pressure roller life.

The spreader 40 can include a cleaning/oiling station 48 associated with image-side roller 42. The station 48 cleans and/or applies a layer of some release agent or other material to the roller surface. The release agent material can be an amino silicone oil having viscosity of about 10-200 centipoises. A small amount of oil transfers from the station to the media web W, with the printer 5 transferring approximately 1-10 mg per A4 sheet-sized portion of the media web W. In one embodiment, the mid-heater 30 and spreader 40 are combined into a single unit, with their respective functions occurring relative to the same portion of media simultaneously. In another embodiment the media is maintained at a high temperature as the media exits the print zone 20 to enable spreading of the ink.

In printer 5, the controller 50 is operatively connected to various subsystems and components to regulate and control operation of the printer 5. The controller 50 is implemented with general or specialized programmable processors that execute programmed instructions to operate one or more electronic components to perform functions or processes. The instructions and data required to perform the programmed functions are stored in a memory 52 that is associated with the controller 50. The processors, their memories, and interface circuitry configure controllers and/or a print engine to perform printer operations. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in VLSI circuits. Also, the circuits described herein can be implemented with a combination of processors, ASICs, discrete components, or VLSI circuits. In the embodiment of FIG. 8, the controller 50 receives image data for printed images in a contone data format and uses the screen or a threshold matrix that is stored in the memory 52 to generate the halftone binary image data that are used to operate the inkjets in the printhead units 21A-21D to control the ejection of ink drops onto the media web W. As described in more detail below, the controller 50 also receives signals from the sensor 62 that indicate variations in the velocity of the media web W. The controller 50 modifies the intensity parameters of the contone image data to reduce or eliminate banding artifacts in the printed image that are produced by the variations in the media web velocity.

The controller 50 is operatively connected to the printheads in the printhead units 21A-21D. The controller 50 generates electrical firing signals to operate the individual inkjets in the printhead units 21A-21D to eject ink drops that form printed images on the media web W. The activated inkjets receive firing signals and eject ink drops at various times during the printing process. The deactivated inkjets do not receive the firing signals, and consequently do not eject ink drops during the printing process.

The printer 5 includes an optical sensor 54 that is configured to generate image data corresponding to the media web W and a backer roller 56. The optical sensor is configured to detect, for example, the presence, intensity values, and/or location of ink drops jetted onto the receiving member by the inkjets of the printhead assembly. The optical sensor 54 includes an array of optical detectors mounted to a bar or other longitudinal structure that extends across the width of an imaging area on the image receiving member. In one embodiment in which the imaging area is approximately twenty inches wide in the cross-process direction and the printheads print at a resolution of 600 dpi in the cross-process direction, over 12,000 optical detectors are arrayed in a single row along the bar to generate a single scanline of image data corresponding to a line across the image receiving member. The optical detectors are configured in association in one or more light sources that direct light towards the surface of the image receiving member. The optical detectors receive the light generated by the light sources after the light is reflected from the image receiving member. The magnitude of the electrical signal generated by an optical detector in response to light being reflected by the bare surface of the media web W, markings formed on the media web W, and portions of a backer roller support member 56 that are exposed to the optical sensor 54. The magnitudes of the electrical signals generated by the optical detectors are converted to digital values by an appropriate analog to digital converter.

During operation, the controller 50 receives contone image data, which typically includes a plurality of image data pixels with color separations, such as red, green, blue (RGB) or CMYK separation values, which correspond to contone planes for the color separations. In one embodiment, each contone pixel includes an 8-bit numeric parameter corresponding to the relative intensity parameter for each of the color separations in the pixel. The minimum value (0) indicating zero intensity in the color separation and the maximum value (255) indicates full intensity of the color at 100% intensity. Intermediate values correspond to different levels of intensity between zero and full intensity.

Since the inkjet printer 5 ejects ink drops in a half-tone print mode, the controller 50 maps the intensity parameters in the contone image data to a modified intensity parameters using a predetermined look-up-table (LUT) that is stored in the memory 52. The LUT is scan line spacing dependent, or tone and scan line spacing dependent. The controller 50 uses the LUT during image processing to account for the physical properties of the printed ink drops, including the propensity of the ink drops to spread on the surface of the media web W. The controller 50 uses the LUT to adjust contone image data in a digital print image to adjusted contone image data having adjusted image intensity parameters in some or all of the pixels. The adjusted contone image data include intensity parameters that conform to the particular physical characteristics of the marking engine in the printer, such as the inkjet printhead units 21A-21D in the printer 5. The controller 50 performs a half-toning process using the LUT-adjusted contone image data as an input to generate binary image data for the control of the printheads to print a half-toned image using the CMYK inks that reproduces the original colors in the contone image.

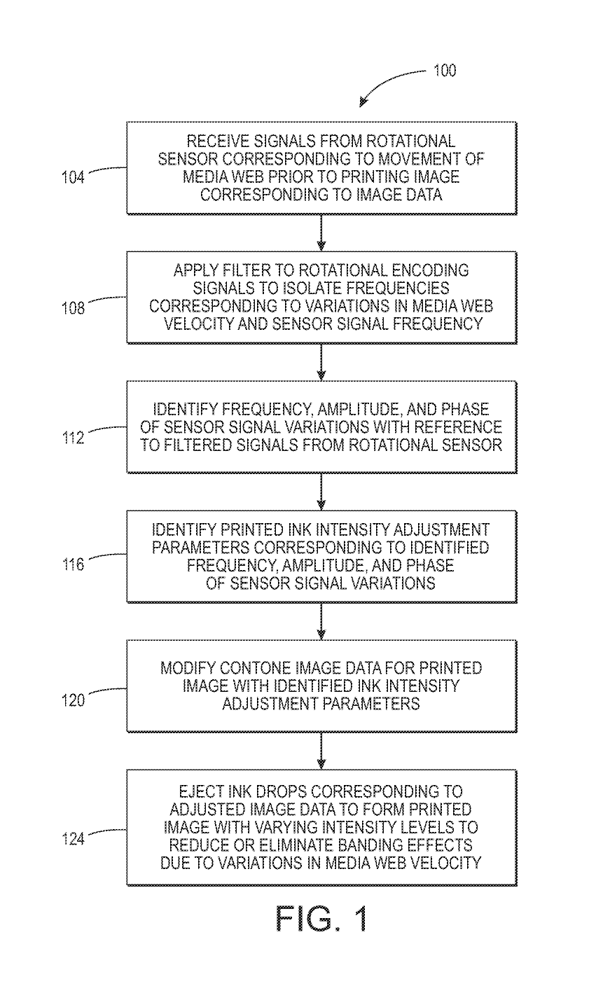

FIG. 1 depicts a process 100 for reducing or eliminating banding in an inkjet printer that prints ink drops onto an image receiving surface with varying velocity. In the discussion below, a reference to the process performing a function or action refers to a controller executing programmed instructions stored in a memory to operate one or more components to perform the function or action. The process 100 is described in conjunction with the printer 5 of FIG. 8 for illustrative purposes.

Process 100 begins as the controller 50 receives the signal from the encoder sensor 62 corresponding to the identified movement of the media web over time prior to printing an image on the media web (block 104). As described above, the signal from the sensor 62 includes a series of pulses that are generated in response to rotation of the roller 27A by a predetermined distance, which correspond to a predetermined linear distance of movement for the media web W in the process direction P. The controller 50 identifies the velocity of the media web W from the frequency of the pulses that are received from the sensor 62. During operation of the printer 5, the velocity of the media web W in the process direction P deviates from a default operating velocity. Since the inkjets in the printhead units 21A-21D eject ink drops at a fixed frequency, the variation in the velocity of the media web W introduces banding artifacts if the printer 5 forms the printed image using the original image data. During process 100, the printer 5 adjusts the intensity parameters of the image data prior to printing the image to reduce or eliminate the effects of banding in the printed image on the media web W.

Process 100 continues as the controller 50 applies a filter, such as a band-pass or low-pass filter, to the signal received from the sensor 62 to identify the variations in the velocity of the media from the default velocity (block 108). In one embodiment, the filter is a band-pass filter with a pass-band that corresponds to the resolution of the angular encoder and the diameter of the rotating drum or disc that is attached to the encoder. In another embodiment, a low-pass filter has a cutoff frequency that is above the expected frequency range of the angular encoder to attenuate high-frequency noise in the signal from the encoder. The encoder measures the counts between a fixed time interval. The filter is applied to the time series of the encoder counts. In general, one can do a frequency analyze on this time series, find out one or more peaks in the frequency domain, and then apply filter accordingly to isolate the signal. The filter removes high-frequency noise in the signal that is received from the sensor 62 to increase the accuracy in identification of variations in the media web velocity. In the printer 5, the controller 50 identifies a frequency, amplitude, and phase of the variations in the signal from the sensor 62 to identify changes in the velocity of the media web W, which produce changes in the separation between printed ink drops that the printhead units 21A-21D eject onto the media web W.

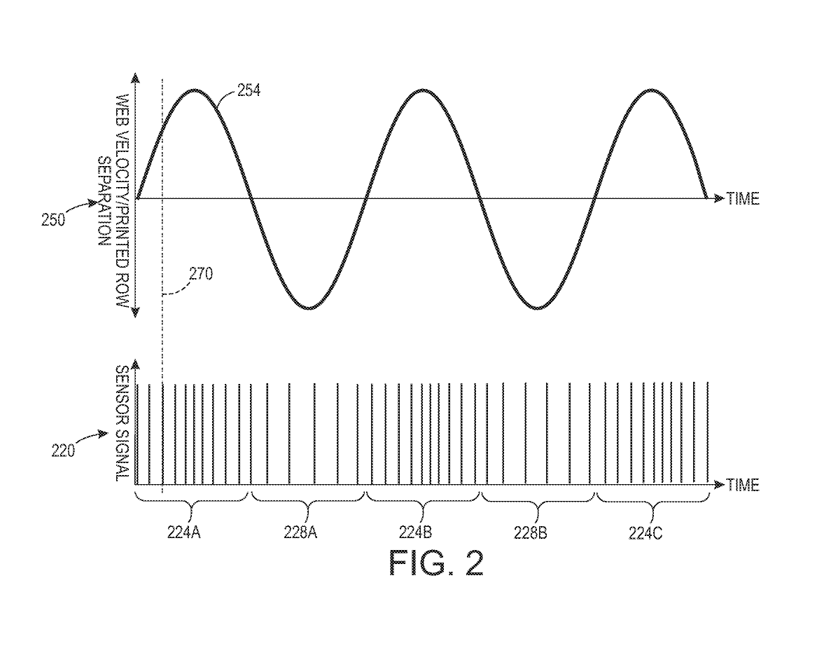

FIG. 2 includes illustrative graphs 220 and 250 that depict the sensor signal and variations in velocity of the media web W, respectively, over time. FIG. 2 depicts a sinusoidal oscillation of the frequency of the signal from the sensor 62 and corresponding velocity of the media web W. The graph 220 includes pulses in the filtered signal from the sensor 62. In the regions 224A, 224B, and 224C, the pulses from the sensor 62 are spaced closer together on the time axis during times when the velocity of the media web W is above a predetermined operating velocity. When the media web W moves at a velocity that is above the predetermined operating velocity, the ink drops from the printhead units 21A-21D are spaced farther apart from one another, which results in a “lighter” band of perceived color with reduced intensity. In the regions 228A and 228B, the signals are spaced farther apart on the time axis during times when the media web W moves at a velocity that is below the predetermined operating velocity. When the media web W moves at a velocity that is below the predetermined operating velocity, the ink drops from the printhead units 21A-21D are spaced closer together, which results in a “darker” band of perceived color with increased intensity. In the example of FIG. 2, the oscillation generates a constant change in the velocity of the media web W over time, which produces a constantly varying degree of higher intensity and lower intensity banding in printed images that are formed on the media web W using prior-art printing techniques.

FIG. 2 depicts a sinusoidal oscillation 254 that is above and below the predetermined operating velocity of the media web W in the graph 250. The velocity variation graph 250 also corresponds to variations in the distance between ink drops that are ejected from each of the inkjets in the printhead units 21A-21D during operation of the printer 5. As the velocity increases above the default operating velocity, the separation between the ink drops increases, while the distance between ink drops decreases as the velocity of the media web W decreases. FIG. 2 depicts a sinusoidal velocity variation for illustrative purposes, but other variations in the velocity of the media web W include different waveforms with varying amplitudes, frequencies, and phases. The variations in the velocity of the media web may change over time during the operation of the printer 5. Additionally, the variations in the velocity of the media web W are not necessarily symmetric with respect to the default operating velocity of the media web W. For example, other oscillation signals include variations in the velocity of the media web W that are entirely above or entirely below the predetermined operating velocity of the media web W.

Referring to FIG. 1 and FIG. 2, the controller 50 identifies the amplitude, frequency, and phase of the variation in the velocity of the media web W over time based on the variations in the signal from the sensor 62 (block 112). The identified amplitude of the variation in velocity corresponds to a degree to which the perceived intensity of the printed image varies from the default intensity when the ink is printed on the media web. Visually, the amplitude affects the intensity of the banding effect in a printed image, with the perceptible effect of the banding increasing with the amplitude of the velocity variation. The identified frequency of the variation corresponds to how often the media web W changes between the maximum and minimum velocities during oscillation. Visually, the frequency of the oscillation corresponds to the length of the bands in the process direction P. The phase of the oscillation corresponds to an offset in the process direction for the location of the bands in a printed image. For example, if the printer 5 begins printing an image when the velocity of the media web W is at a maximum level, then the printed image includes a light band at one edge of the image and the banding effects continue for a length of the printed image in the process direction. If the printer 5 prints the same ink image beginning when the velocity of the media web W is at a minimum level, then the printed image includes a dark band at the edge of the image and the banding effects continue for a length of the printed image in the process direction.

Process 100 continues as the controller 50 identifies intensity adjustment parameters for a printed image using the identified amplitude, frequency, and phase of the variation in web velocity in conjunction with a predetermined lookup table or other database of intensity adjustment parameters that is stored in the memory 52 (block 116). The controller 50 identifies an entry for one or more rows of contone image data in the lookup table with reference to a predicted velocity of the media web and corresponding spacing between ink drops for the time when the printer 5 ejects the ink drops corresponding to the image data based on the observed variations in the signal from the sensor 62.

For example, the controller 50 begins printing an image corresponding to received image data at a predetermined time after receiving the contone image data. The controller 50 also receives the signal from the sensor 62 during a time period prior to beginning the printing operation. The controller 50 identifies the expected frequency of the signal from the sensor 62 and the corresponding velocity of the media web at the time corresponding to the commencement of the printing process with reference to the previously identified variation in the signal from the sensor 62. The identified phase of the variations in the signal from the sensor 62 enables the controller 50 to identify the velocity of the media web W within the oscillation at the time when the inkjets commence the printing operation. The controller 50 then identifies predicted changes to the velocity of the media web over time during the printing of subsequent portions of the printed image using the identified amplitude and frequency of the variations in the signals from the sensor 62. For example, in FIG. 2 the controller 50 identifies a predicted velocity of the media web at time 270 when the printer 5 commences printing an image. The controller 50 retrieves image intensity adjustment parameters from the memory 52 with reference to the predicted frequency of the sensor signal at time 270. The controller 50 optionally retrieves additional image intensity adjustment parameters from the memory 52 for additional rows of the image data that are printed as part of the image using the predicted variations in the velocity of the media web W over time. In one embodiment, the controller 50 identifies image intensity adjustment parameters for each row of contone pixels in a single printed image prior to beginning the process of forming the image, while in another embodiment the controller 50 identifies image intensity adjustment parameters for a portion of the rows of image data or on a single row basis.

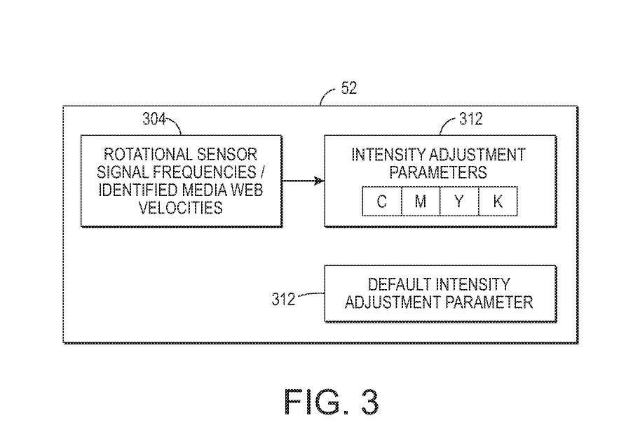

FIG. 3 depicts an example of the lookup table in the memory 52. In FIG. 3, an index table 304 stores a plurality of identified signal frequencies for the sensor 62 that correspond to different velocities of the media web W. Each entry in the index table 304 corresponds to a predetermined intensity adjustment parameter stored in the table 308. The intensity adjustment parameters 308 are numeric adjustments that are applied to image data that either reduce or increase the intensities of contone image data pixels. In one embodiment, each entry in the table 308 includes different adjustment parameters for each of the cyan, magenta, yellow, and black (CMYK) color separations in the printer 5, while in another embodiment each entry in the table 308 includes a single intensity adjustment parameter.

In the printer 5, the intensity adjustment parameters in the table 308 further modify a default intensity adjustment level 312 that is applied to all pixels in the contone image data. The default intensity adjustment level 312 reduces the intensity of all contone image data pixels during operation of the printer 5. The default intensity adjustment level 312 reduces the intensity, by means of offsetting, scaling, or table-look-up, of all contone pixels to enable a relative increase in the intensities of selected contone pixels without regard to the original intensity parameters of the pixels. The default intensity adjustment parameter can reduce the numeric parameters for some low-intensity pixels to zero, but the low-intensity pixels are typically less visible during a printing operation than the higher intensity pixels. The default intensity adjustment parameter 312 lowers the intensity value of the pixel, and all other pixels in the image, by a predetermined amount. This predetermined amount can be tone-dependent. For example, if the original contone image data includes a pixel with an intensity parameter value of 255, which is a maximum intensity for the pixel, then the controller 50 is unable to increase the intensity for the pixel during image processing prior to a printing operation. Thus, the default adjusted pixel has an intensity of, for example, 240 instead of 255. The intensity adjustment parameters 308 further modify the intensity of the pixel by, for example, increasing the intensity of the pixel by up to the maximum intensity or by further decreasing the intensity of the pixel. This default reduction adjustment parameter is not normally implemented on a regular printer. One use of this mechanism can be seen on the printer where the additional ink is added from the neighboring pixel locations to compensate for the missing ink at the current location.

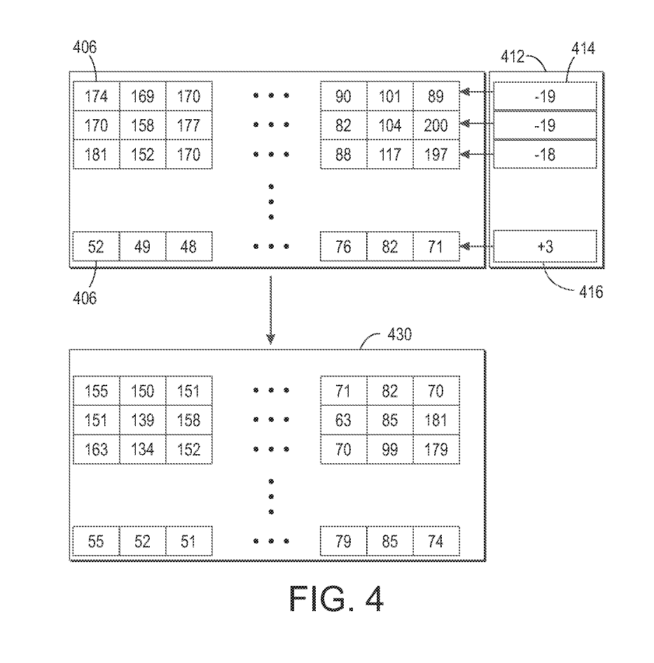

Referring again to FIG. 1, the controller 50 modifies the contone image data for the printed image using the identified ink intensity parameters (block 120). The controller 50 increases or decreases the image intensity parameter for each pixel in the contone image data using the selected image intensity adjustment parameter. FIG. 4 depicts an illustrative sample of single-separation contone image data 404 and corresponding image data adjustment parameters 412 that the controller 50 retrieves from the memory 52. The controller 50 adds the image data adjustment parameter to each pixel in a row of pixels. The image data adjustment parameters can have negative values to decrease the intensity of pixels in a row of image data, or a positive value to increase the intensity of the pixels in the row of image data. As described above, the controller 50 selects different image adjustment parameters for different regions in the printed image. For example, in FIG. 4 the controller 50 applies an intensity adjustment parameter 414 with a negative value (−19) to the row of pixels 406, but applies a positive adjustment parameter 416 (+3) to another row of pixels 406 in a different region of the printed image. In FIG. 4, the image data 430 include pixels with the modified image intensity parameter values. The printer 5 forms the printed image on the media web W using the modified image data 430 instead of the image data 404. FIG. 4 depicts image data for a single color separation. In the printer 5, the controller 50 applies the image intensity adjustment parameter to contone image data for each of the CMYK colors. The example in FIG. 4 shows a constant adjustment value across the entire row, disregarding what the original contone value is. In another embodiment, the adjustment value 414 can also be tone-dependent. For example, the row 406, the adjustment for the first pixel can be -19, while the adjustment for the second pixel can be −18, depending on the intensity of the contone value before adjustment.

Process 100 continues as the printer 5 operates inkjets in the printhead units 21A-21D to form a printed image on the media web W with the effects of banding being reduced or eliminated in the printed image (block 124). In the printer 5, the controller 50 performs a dithering process using the threshold matrices that are stored in the memory 52 to generate binary image data for printing half-tone patterns that reproduce the colors in the modified contone image data. The printhead units 21A-21D receive the binary image data and generate firing signals for the inkjets to form the printed image on the media web W. The process 100 is repeated for multiple printed images that are formed on the media web W during a print job. If changes occur in the variation of the media web velocity, the controller 50 identifies the changes and updates the modifications to the intensities of the contone image data to reduce or eliminate the banding artifacts during the print job.

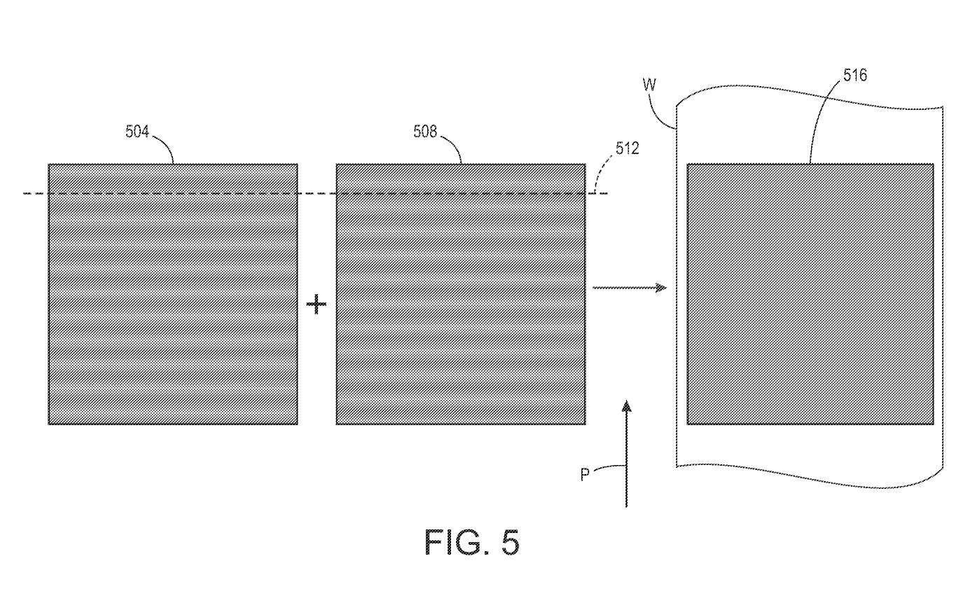

FIG. 5 depicts a default image 504 that is formed with a banding effect on a media web with varying velocity. The process 100 modifies the image data for the printed image to generate the modified image 508. If printed on an image receiving surface that moves with constant velocity, the modified image 508 would also include banding, but the phase of the banding in the image 508 is offset from the phase of the banding in the original image 504. For example, the row 512 passes through a region of reduced intensity in the original image 504, and a corresponding region of increased intensity in the modified image 508. Because the media web W passes through the print zone 20 with the varying velocity that corresponds to the banding patterns, the modified image data 508 cancel the banding patterns in the original image data 504. As depicted in FIG. 5, the printed image 516 formed on the media web W does not include the visible banding effect.

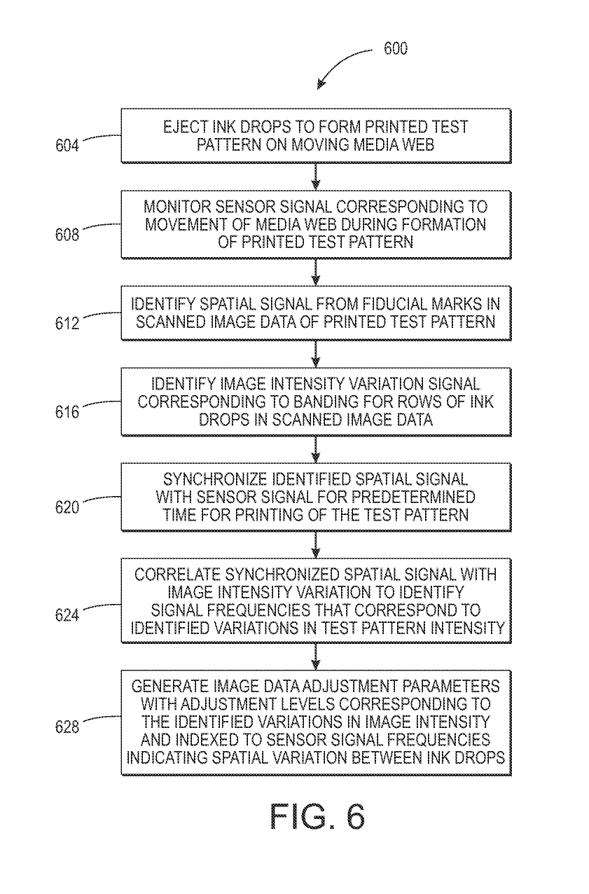

As described above, during process 100 the controller 50 identifies predetermined image intensity adjustment parameters in the memory 52 for the image data that correspond to varying frequency levels of the signal from the sensor 62 and corresponding varying velocities of the media web W. FIG. 6 depicts a process 600 for generating the image intensity adjustment parameters. In the discussion below, a reference to the process performing a function or action refers to one or more processors and controllers executing programmed instructions stored in a memory to operate one or more components to perform the function or action. The process 600 is described in conjunction with the printer 5 of FIG. 8 for illustrative purposes.

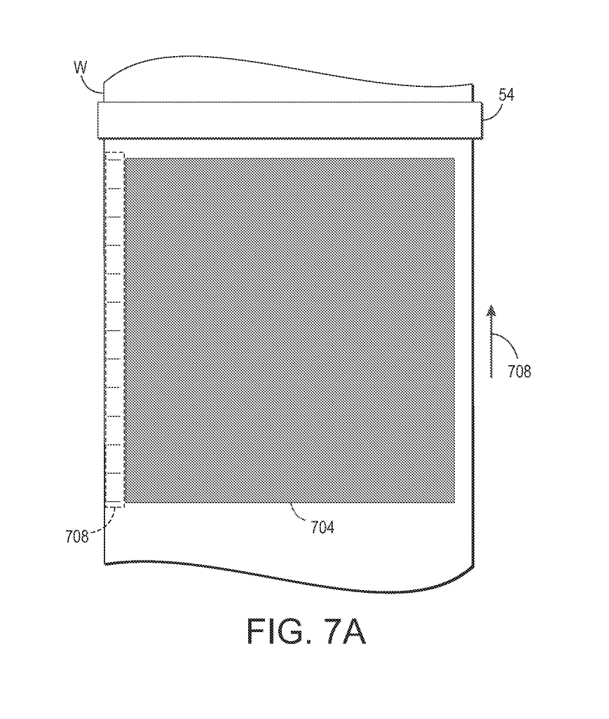

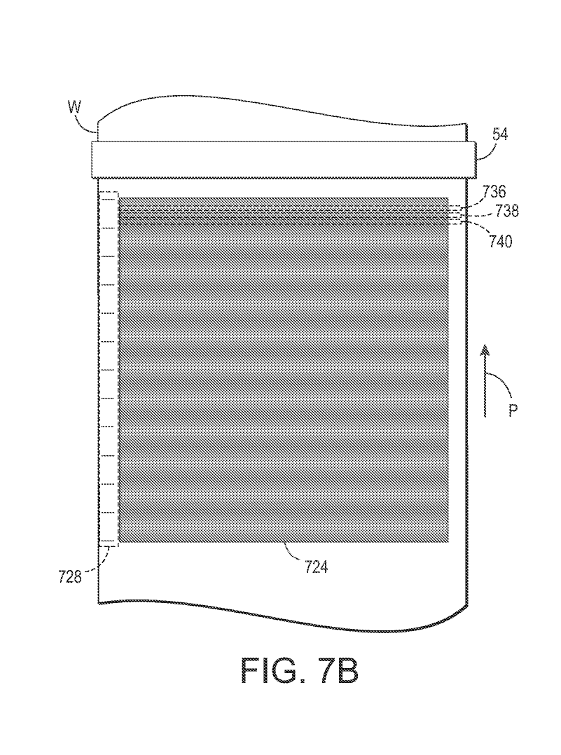

Process 600 begins as the printer 5 ejects ink drops to form a printed test pattern on the media web W (block 604). FIG. 7A depicts a test pattern including a printed patch 704 that is formed with a predetermined intensity. In one embodiment, the patch 704 is formed with an intensity at approximately the middle of a range between the minimum and maximum intensity for the printer 5. The printer 5 also prints fiducial marks 708 that are formed at predetermined times while the patch 704 is printed. The fiducial marks 708 enable the identification of the time when different portions of the path 704 are printed for synchronization with the signal from the sensor 62. FIG. 7A depicts a printed patch 704 that is formed when the media web W moves at a constant velocity through the print zone. FIG. 7B depicts the same printed test pattern when the velocity of the media web W varies while printing the test pattern during the process 600. In FIG. 7B, the printed patch 724 exhibits banding. The fiducial marks 728 are used to identify the time at which different portions of the printed test patch 724 were formed on the media web W.

Referring again to FIG. 6 and FIG. 7B, the controller 50 monitors the signal from the rotational sensor 62 during printing of the test pattern (block 608). As described above, the signal from the sensor 62 corresponds to the velocity of the media web W, and the variations in the frequency of the signal correspond to variations in the velocity of the media web W. The fiducial marks 728 that are printed at predetermined times are synchronized to the identified frequency of the signal from the sensor 62 at the predetermined times to identify the velocity of the media web W in different regions of the printed test patch 724.

Process 600 continues with identification of a spatial signal from the printed fiducial marks (block 612) and identification of a corresponding spatial variation in the image intensity of the printed test patch 724 (block 616). An optical scanner, such as the sensor 54 or an external optical sensor, generates scanned image data of the test patch 724 and the fiducial marks 728. The controller 50 or an external digital image processing device identifies the variations in the intensity of the printed patch 724 and synchronizes the identified variation in time with the predetermined times during which the printer 5 forms the fiducial marks 728 (block 620). For example, in FIG. 7B the controller 50 identifies portions of the scanned image data that correspond to a reduced intensity portion of the printed patch 724 in the region 736, an intermediate intensity portion in region 738, and an increased intensity portion in the region 740. In FIG. 7B, the actual spacing between fiducial marks should be a lot smaller than what is shown. With the appropriate magnification, conceptually, one should be able to observe that the fiducial marks are further apart in the region of 736, while the marks are closer in the region of 740.

Process 600 continues as the controller 50 correlates the synchronized spatial signal for varying intensities from the scanned data of the printed test pattern to the variations in the signal from the sensor 62 (block 624). The controller 50 identifies the frequency of the signal from the sensor 62 that is measured at the time when a portion of the printed patch 724 is formed with the identified intensity value. The controller 50 applies a band-pass or low-pass filter to the signal from the sensor 62 to attenuate noise in the signal in frequencies that are outside the range of expected variations in the velocity of the media web W. In FIG. 7B, the patch 724 includes multiple repetitions of the banding pattern, the controller 50 identifies an average variation in the intensity of the scanned data corresponding to the same frequency of the signal from the sensor 62 in multiple regions of the test patch 724 to improve the accuracy of the correlation between sensor signal frequency and the variation in printed image intensity.

Process 600 continues with generation of the image data adjustment parameters that compensate for the identified variation in the intensity of the printed test patch due to banding, and are indexed to the identified frequencies of the signal sensor 62 that are detected at the time of the variation in the printed pattern intensity (block 628). In the printer 5, the controller 50 identifies the adjustment parameter for the contone image intensity values using the look-up-tables (LUTs) in reverse. The reverse LUT generates an intensity adjustment parameter for contone image data given the identified variation in intensity of the printed half-tone pattern due to the banding in the printed patch 724. The intensity adjustment parameter adjusts the intensity of the contone image data to remove the identified variation in intensity from the printed pattern. For example, for a given frequency of the signal from the sensor 62, the controller 50 uses the reverse LUT to identify that the intensity of the printed patch 724 is increased above the default intensity by a numeric value of +10, such as in the darker portion of the band 740. The corresponding intensity adjustment parameter is a −10 to remove the effects of banding in the contone image data when the sensor 62 generates the signal at the identified frequency corresponding to the velocity of the media web W.

During process 600, the controller 50 or another digital image processing device identifies the intensity adjustment parameters corresponding to an expected range of frequencies for the signal from the sensor 62 that occur during operation of the printer 5. In the printer 5, the memory 52 stores the lookup table or other database having the identified image intensity adjustment parameters that are indexed to different frequencies for the signal from the rotational sensor 62, as depicted above in FIG. 3. In a multi-color printer such as the printer 5, the process 600 is optionally performed for each of the cyan, magenta, yellow, and black inks to identify banding variations and image intensity adjustment parameters for each of the ink colors.

It will be appreciated that various of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method of operating a printer comprising:
moving a media web in a process direction past a plurality of inkjets in a print zone;
generating a signal corresponding to process direction movement of the media web with a sensor;
identifying variations in a frequency of the signal from the sensor;
identifying a plurality of intensity adjustment parameters for a printed image with reference to the identified variations in the frequency of the signal from the sensor;
modifying image data for the printed image with reference to the plurality of identified intensity adjustment parameters; and
ejecting ink drops to form the printed ink image on the media web with reference to the modified image data to reduce or eliminate variations in an intensity of the printed ink image.

2. The method of claim 1 further comprising:
applying a filter to the signal from the sensor prior to the identification of the variations in the frequency of the signal.

3. The method of claim 2, the application of the filter further comprising:
applying a band-pass filter having a frequency pass-band corresponding to a rate of rotation of an angular encoder that rotates in response to the movement of the media web to the signal.

4. The method of claim 2, the application of the filter further comprising:
applying a low-pass filter having a cutoff frequency that is greater than a frequency of rotation of an angular encoder that rotates in response to the movement of the media web to the signal.

5. The method of claim 1, the identification of the variations in the frequency of the signal from the sensor further comprising:
identifying variations in at least one of the frequency and phase of the signal from the sensor with reference to a predetermined frequency and phase of the signal.

6. The method of claim 5, the identification of the plurality of intensity adjustment parameters further comprising:
identifying a period of the variations of the frequency for the signal from the sensor;
identifying an amplitude of the variations of the frequency for the signal from the sensor; and
identifying the plurality of intensity adjustment parameters for the image data with reference to the identified period and amplitude of the variations of the frequency for the signal from the sensor.

7. The method of claim 6 further comprising:
identifying the plurality of intensity adjustment parameters for the image data with reference to the identified phase of the signal from the sensor.

8. The method of claim 1, the identification of the plurality of adjustment parameters further comprising:
identifying an increased level of image intensity above a predetermined level for the printed image with reference to a decrease in the frequency of the signal from the sensor below a predetermined frequency; and
identifying one of the plurality of intensity adjustment parameters with reference to a decreased image intensity corresponding to the identified increased level of image intensity and a predetermined lookup table.

9. The method of claim 1, the identification of the plurality of adjustment parameters further comprising:
identifying a decreased level of image intensity below a predetermined level for the printed image with reference to an increase in the frequency of the signal from the sensor above a predetermined frequency; and
identifying one of the plurality of adjustment parameters with reference to an increased image intensity corresponding to the identified decreased level of image intensity and a predetermined lookup table.

10. A printer comprising:
a media transport configured to move a media web in a process direction past a plurality of inkjets in a print zone;
a sensor operatively connected to a member in the media transport and configured to generate a signal in response to movement of the media web;
a memory configured to store a plurality of predetermined intensity adjustment parameters for a printed image with reference to a plurality of frequencies of the signal from the sensor; and
a controller operatively connected to the inkjets, the sensor, and the memory, the controller being further configured to:
identify variations in the frequency of the signal from the sensor;
identify a plurality of intensity adjustment parameters for a printed image with reference to the identified variations in the frequency of the signal from the sensor and the predetermined intensity adjustment parameters stored in the memory;
modify image data for the printed image with reference to the plurality of identified intensity adjustment parameters; and
generate firing signals to eject ink drops from the plurality of inkjets onto the media web to form the printed image with reference to the modified image data to reduce or eliminate variations in an intensity of the printed ink image.

11. The printer of claim 10, the controller being further configured to:
apply a filter to the signal from the sensor prior to the identification of the variations in the frequency of the signal.

12. The printer of claim 11, the controller being further configured to:
apply a band-pass filter having a pass-band corresponding to a frequency of rotation of an angular encoder that rotates in response to the movement of the media web.

13. The printer of claim 11, the controller being further configured to:
apply a low-pass filter having a cutoff frequency that is greater than a frequency of rotation of an angular encoder rotates in response to the movement of the media web.

14. The printer of claim 10, the controller being further configured to:
identify variations in at least one of the frequency and phase of the signal from the sensor with reference to a predetermined frequency and phase of the signal.

15. The printer of claim 14, the controller being further configured to:
identify a period of the variations of the frequency for the signal from the sensor;
identify an amplitude of the variations of the frequency for the signal from the sensor; and
identify the plurality of intensity adjustment parameters for the image data with reference to the identified period and amplitude of the variations of the frequency for the signal from the sensor.

16. The printer of claim 15, the controller being further configured to:
identify the plurality of intensity adjustment parameters for the image data with reference to the identified phase of the signal from the sensor.

17. The printer of claim 10, the controller being further configured to:
identify an increased level of image intensity above a predetermined level for the printed image with reference to a decrease in the frequency of the signal from the sensor below a predetermined frequency; and
identify one of the plurality of intensity adjustment parameters with reference to a decreased image intensity corresponding to the identified increased level of image intensity and a predetermined lookup table.

18. The printer of claim 10, the controller being further configured to:
identify a decreased level of image intensity below a predetermined level for the printed image with reference to an increase in the frequency of the signal from the sensor above a predetermined frequency; and
identify one of the plurality of adjustment parameters with reference to an increased image intensity corresponding to the identified decreased level of image intensity and a predetermined lookup table.
